(19) United States
(12) Patent Application Publication
(10) Pub. No.: US 2023/0087641 A1
(43) Pub. Date: Mar. 23, 2023

(54) CROSS-DEVICE CONTENT TRANSFER

(71) Applicant: Intel Corporation, Santa Clara, CA (US)

(72) Inventors: Glen J. Anderson, Beaverton, OR (US); Kimi Jensen, Beaverton, OR (US); Maria Pitallano, Santa Clara, CA (US); Tiffany Romain, Santa Clara, CA (US)

(21) Appl. No.: 18/060,287

(22) Filed: Nov. 30, 2022

(51) Int. Cl. G06F 3/01; G06T 13/40

(52) U.S. Cl. CPC G06F 3/013; G06T 13/40

(57) ABSTRACT

Methods, apparatus, systems, and articles of manufacture are disclosed for cross-device content transfer. An example first electronic device disclosed herein includes processor circuitry to at least one of instantiate or execute machine-readable instructions to detect a second electronic device; detect an action of a user of the first electronic device; compare the action to a ruleset; facilitate transfer of content from the first electronic device to the second electronic device when the action complies with the ruleset; and prevent transfer of content from the first electronic device to the second electronic device when the action does not comply with the ruleset.

### FIELD OF THE DISCLOSURE

This disclosure relates generally to electronic devices and, more particularly, to cross-device content transfer.

### BACKGROUND

Sometimes users of electronic devices want to view content on two electronic devices. Some conventional applications allow both electronic devices to access the content from a common cloud-based database.

### BRIEF DESCRIPTION OF THE DRAWINGS

FIG. 1 is a block diagram of an example system of networked devices.

FIG. 2 is a table of an example cross-device transfer ruleset.

FIG. 3 is a flowchart representative of example machine readable instructions and/or example operations that may be executed by example processor circuitry to implement the user devices of FIG. 1.

FIG. 4 is a block diagram of an example processing platform including processor circuitry structured to execute the example machine readable instructions and/or the example operations of FIG. 3 to implement the user devices of FIG. 2.

FIG. 5 is a block diagram of an example implementation of the processor circuitry of FIG. 4.

FIG. 6 is a block diagram of another example implementation of the processor circuitry of FIG. 4.

FIG. 7 is a block diagram of an example software distribution platform (e.g., one or more servers) to distribute software (e.g., software corresponding to the example machine readable instructions of FIG. 3) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale.

### DETAILED DESCRIPTION

Users of electronic devices may desire to acquire content from one electronic device for presentation at another electronic device. For example, a first user of a first electronic device may want to share content with a second user of a second electronic device. In another example, a user of a first electronic device may want to send content from the first electronic device to a second electronic device, when both the first and the second electronic devices are operated by the user. For example, the user may want to send content from a personal computer (PC) to a head-mounted display (HMD). The sharing of content between devices is known as cross-device content transfer.

There are challenges with cross-device content transfer. For example, a virtual reality (VR) HMD can cut the user off from the real environment, making their PCs and phones invisible to the user. In another example, augmented reality (AR) HMDs allow the user to see through to the real environment, but the users may be using other input devices for the HMD, so it may not be convenient to switch to and from the other input devices (e.g., a mouse, a keyboard, a touch screen). In addition, many HMDs are standalone devices and not primarily PC peripherals. Similarly, smartphones also are standalone devices and not primarily PC peripherals. Peripherals are auxiliary devices that are designed to communicate with the PC and do not operate as standalone devices. Standalone devices are separate electronic devices that function independently. Examples disclosed herein facilitate cross-device content transfer between electronic devices such as standalone devices.

Examples disclosed herein enable a user to easily transfer content across electronic devices. For example, an example system disclosed herein enables the user of an AR or VR HMD and a PC to be able to transfer content between the PC and the HMD while the user is wearing the HMD. The content transfer functionality utilizes a ruleset, digital context, and cross-device sensing. An example ruleset includes default rules that correlate user action with computer action and/or other action taken by the system. Example digital context relates to the content material presented via the electronic devices. Example cross-device sensing includes sensors and circuitry that may be used to sense other devices, user actions, and/or other commands. Example sensors and circuitry include cameras, ultra-wideband wireless communication protocol circuitry, microphones, and/or capacitive surfaces, etc. Other example sensors and circuitry are disclosed herein. The ruleset, digital context, and cross-device sensing enable an example system to facilitate new and/or alternative interactions between electronic devices. The interactions may be based on a change in operating characteristics including, for example, input and output capabilities of one or more of the electronic devices.

An example interaction includes an example system automatically changing input and output operations of a first electronic device based on operation of a second electronic device to facilitate cross-device content transfer. For example, the system can detect or track that a user has put on an HMD such as, for example, an AR HMD. The system automatically switches a camera or touch screen of a PC to an air or touch gesture detection mode that is specific to the HMD. This allows the user to gesture to move content from the PC to the HMD. In some examples, a gesture camera on the HMD is additionally or alternatively used to detect the gesture.

Another example interaction includes an example system detecting a user gesture toward a first device and automatically presenting content from the first device on a display of the second device to facilitate cross-device content transfer. For example, the system detects or tracks that a user has put on an HMD such as, for example, an AR HMD. While wearing the AR HMD, the user could make a gesture toward a phone. The gesture is detected by the HMD, and the system displays content from the phone on the HMD.

Another example interaction includes an example system detecting a user verbal command to facilitate cross-device content transfer. For example, the system detects or tracks that a user has put on an HMD such as, for example, an AR HMD. While wearing the AR HMD, the user could initiate a passthrough command verbally. For example, the user may say, “show the Word document I was using on my PC.” The system causes a virtual version of the PC display to appear on the HMD with content of interest.

Another example interaction includes an example system detecting a user eye gaze to facilitate cross-device content transfer. For example, the system detects or tracks that a user has put on an HMD. The system could track user gaze toward a screen of a tablet, and the user could start a copy mode that selects an object from the tablet to bring into the HMD view. The user may select content by moving their head to make a selection on the tablet through the HMD.

Another example interaction includes an example system presenting content from a first device on a second device after the user provides a command. For example, when coming out of an AR or VR session, the user could indicate a different device and give a command (e.g., via gesture, voice, combination) to continue the HMD content there.

Another example interaction includes the user providing a command with an eye gaze and a confirmation action. For example, when coming out of an HMD session and returning to operate a PC, the user may control the audio. For example, the user may choose to transfer audio to earbuds by gazing at the earbuds through the HMD, and then the user confirms by entering a selection via an HMD touch input.

Another example interaction includes a first user providing a command to transfer content to a second user using eye gaze. For example, a first user could gaze on a second user's device or the first user can make virtual eye contact with the second user (e.g., in a VR environment) to copy or show content to the second user, when the users are not sharing the same virtual view. Tracking the user gaze could be done in the physical world (e.g., looking at the other user's headset), or it could be done virtually (e.g., looking at the other user's avatar) by correlating user gaze on a first device (e.g., PC) with an avatar in the virtual space on a second device (e.g., an HMD).

Another example interaction includes a translation table that maps inputs across devices according to user preferences and/or default actions. Such a table may be stored and accessible via an application programming interface (API). For example, while wearing an HMD, a user may point toward a laptop, and establish a passthrough experience to the laptop using a virtual keyboard and mouse on an HMD. The translation table maps the inputs on the HMD with those of the laptop.

Different aspects of these examples may be combined with other aspects or other examples disclosed throughout this patent. For example, other examples may include other combinations of electronic devices, other inputs, other command detections, and/or other types of content.

The term “device” or “devices” is not limited to any particular type of device. As understood herein “device” includes any time of electronic device such as, for example, a PC, an HMD, a laptop, a tablet, a smartwatch, a smartphone, a fitness tracker, goggles, glasses, a smart television, earbuds, speakers, an Internet of things (IoT) device, and/or other type of electronic device capable of presenting content.

The term “content” refers to text, images, video, sounds, sensations, and/or other type of audio, visual, and/or haptic media.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

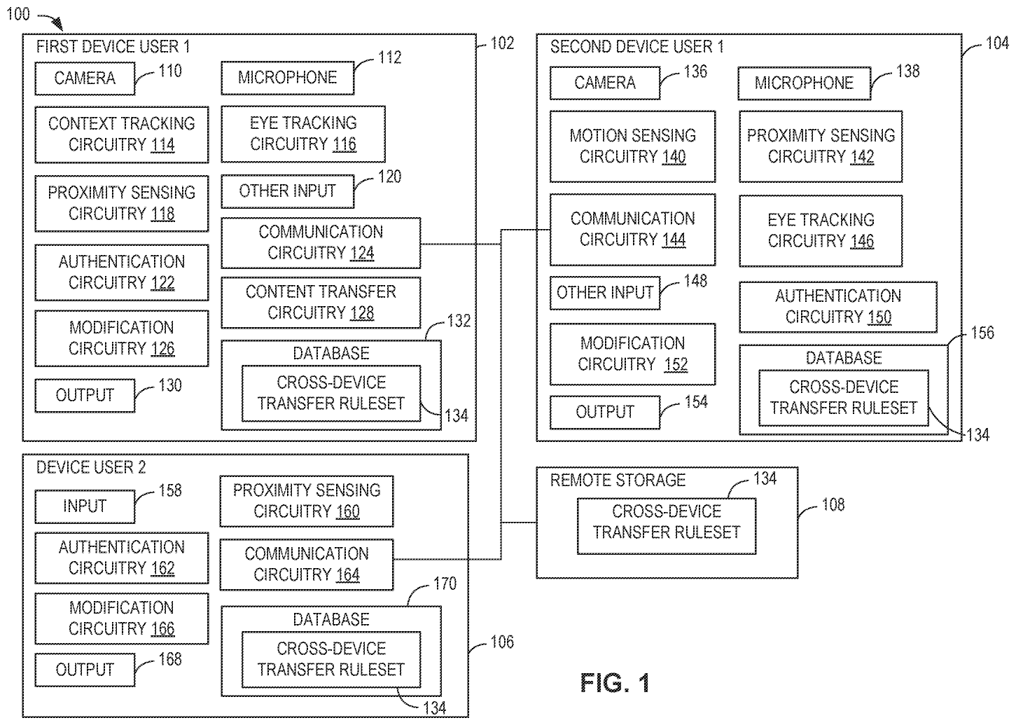

Turning to the figures, FIG. 1 is a block diagram of an example system 100 of networked devices including, for example, an example first device of a first user (“User1/Device1”) 102, an example second device of the first user (“User1/Device2”) 104, an example device of a second user (“User2/Device”) 106, and example remote storage 108. The User1/Device1 102, the User1/Device2 104, the User2/Device 106, and/or the remote storage 108 may be directly coupled (e.g., via wire) and/or wirelessly connected. In some examples, the network is a local network, the Internet, a cloud-based network, and/or an edge-based network, etc. In some examples, one or more of the User1/Device1 102, the User1/Device2 104, the User2/Device 106, and/or the remote storage 108 may or may not appear in the system 100. For example, in some examples, the system 100 includes the first device of the User1/Device1 102 and the User1/Device2 104 but not the User2/Device 106 or the remote storage 108. In other examples, the system 100 includes the User1/Device1 102 and the User2/Device 106 but not the User1/Device2 104 or the remote storage 108. Any combination of the devices may be included in the system 100 in other examples. Also, in other examples, there may be other devices such as additional devices for one or more of the first user and/or the second user and/or additional devices for a third or further additional users.

The User1/Device1 102 includes an example camera 110, an example microphone 112 (or microphone array), example content tracking circuitry 114, example eye tracking circuitry 116, example proximity sensing circuitry 118, example other input 120, example authentication circuitry 122, example communication circuitry 124, example modification circuitry 126, example content transfer circuitry 128, an example output 130, and an example database 132 storing and/or accessing an example cross-device transfer ruleset.

The User1/Device2 104 includes an example camera 136, an example microphone 138 (or microphone array), example motion sensing circuitry 140, example proximity sensing circuitry 142, example communication circuitry 144, example eye tracking circuitry 146, example other input 148, example authentication circuitry 150, example modification circuitry 152, an example output 154, and an example database 156. In some examples, the database 156 of the User1/Device2 104 also stores and/or accesses the example cross-device transfer ruleset 134.

The User2/Device 106 includes an example input 158, example proximity sensing circuitry 160, example authentication circuitry 162, example communication circuitry 164, example modification circuitry 166, an example output 168, and an example database 170. In some examples, the database 156 of the User2/Device 104 also stores and/or accesses the example cross-device transfer ruleset 134.

The example remote storage 108 also stores and/or accesses the example cross-device transfer ruleset 134. In some examples, the remote storage 108 is a cloud-based or edge-based database. In some examples, the cross-device transfer ruleset 134 is the same among all devices. In some examples, the cross-device transfer ruleset 134 is the same among the User1/Device1 102 and the User1/Device2 104 but different for the User2/Device 106. In some examples, the cross-device transfer ruleset 134 is different between the User1/Device1 102 and the User1/Device2 104. In some examples, all devices 102, 104, 106 have different rulesets 134. In some examples, the remote storage 108 may include one or more of the different rulesets 134 for accessibility by any or all of the devices 102, 104, 106. Also, in some examples, one or more of the features or components shown in one or more of the devices 102, 104, 106 in FIG. 1 may be included alternatively or additionally in one or more of other ones of the devices 102, 104, 106. In some examples, components of the devices 102, 104, 106 with the same labels perform similar and/or complementary functions.

There may be different types of interactions between the devices 102, 104, 106 in the system 100. For example, the first user may use the User1/Device1 102 (e.g., a PC) and may also start using the User1/Device2 104 (e.g., an HMD). The first user may want to share the content view from the User1/Device1 102 to the User1/Device2 104. For example, the first user may want to show the content from their PC display on their HMD.

The proximity sensing circuitry 118 of the User1/Device1 102 and the proximity sensing circuitry 142 of the User1/Device2 104 operate so the User1/Device1 102 detects the presence of the User1/Device2 104 in proximity to the User1/Device1 102. The proximity sensing circuitry 118 of the User1/Device1 102 and/or the proximity sensing circuitry 142 of the User1/Device2 104 may utilize one or more of different approaches for sensing device proximity. For example, Bluetooth® may be used for proximity sensing. In another example, relative positions and/or orientations of devices can be employed for proximity sensing between devices. The relative positioning and/or orientation approach is similar to proximity sensors that detects when a user is holding a phone to their ear and automatically disables buttons on the touch screen. In other examples, the proximity sensing circuitry 118 of the User1/Device1 102 and the proximity sensing circuitry 142 of the User1/Device2 104 may use a low power radio protocol such as, for example, ultra-wideband (UWB), which allows location detection of other devices with high resolution. One or more of the camera 110, the microphone 112, the other input 120, and/or the communication circuitry 124 of the User1/Device1 102 and/or one or more of the camera 136, the microphone 138, the motion sensing circuitry 140, the other input 148, and/or the communication circuitry 144 of the User1/Device2 104 also may be used in proximity sensing.

Devices detected in proximity also are authenticated to allow cross-device content transfer. The authentication circuitry 122 of User1/Device1 102 and/or the authentication circuitry 150 of the User1/Device2 104 operate to effect authentication of the User1/Device2 104. The User1/Device2 104 is to be authenticated to verify that the User1/Device2 104 is a trusted device for the User1/Device1 102 (or vice versa). An example authentication approach includes the authentication circuitry 150 the User1/Device2 104 authenticating the first user (i.e., the user of the User1/Device1 102) via authentication methods including, for example, face recognition on the User1/Device2 104. Then the authentication circuitry 122 of the User1/Device1 102 allows authentication automatically based on the proximity of that authenticated user of User1/Device2 104. In some examples, the User1/Device2 104 is installed with a token to facilitate authentication. This approach avoids wireless transmission of biometric data. In some examples, the first user authenticates the User1/Device1 102 and the User1/Device2 104 individually with biometrics, passwords, etc.

When the User1/Device2 104 is authenticated, the content transfer circuitry 128 reevaluates input and output defaults across all devices in the device continuum (e.g., the system 100). In some examples, content transfer circuitry 128 changes an operating characteristic of the User1/Device1 102 based on detection of the User1/Device2 104. In some examples, content transfer circuitry 128 changes an operating characteristic of the User1/Device1 102 based on detection of a communication link between the of the User1/Device1 102 and the User1/Device2 104. In some examples, the operating characteristic change is a disabling of an input device (e.g., the camera 110, the microphone 112, the eye tracking circuitry 116, the other input 120 such as, for example, a mouse, a touchpad, a keyboard, etc.) of the User1/Device1 102. In some examples, the operating characteristic change is a disabling of an output device (e.g., the output 130, which may be a display, a speaker, etc.) of the User1/Device1 102.

Additionally or alternatively, in some examples, content transfer circuitry 128 changes an operating characteristic of the User1/Device2 104 based on detection of the User1/Device2 104 in proximity to the User1/Device1 102. In some examples, the operating characteristic change is a disabling of an input device (e.g., the camera 136, the microphone 138, the eye tracking circuitry 146, the motion sensing circuitry 140, the other input 148, etc.) of the User1/Device2 104. In some examples, the operating characteristic change is a disabling of an output device (e.g., the output 154, which may be a display, a speaker, etc.) of the User1/Device2 104. In some examples, the change of an operating characteristic of one or more of the User1/Device1 102 and/or the User1/Device2 104 includes changing which of the User1/Device1 102 and/or the User1/Device2 104 is to process commands from the first user.

There are many types of example interactions or combinations of interactions of the first user with one or more of the User1/Device1 102 and/or User1/Device2 104, such as for example, using virtual eye contact to establish content transfer, gaze tracking for User1/Device2 104 (e.g., HMD) content acquisition from another device (e.g., User1/Device1 102), and/or combined context sensing via the context tracking circuitry 114 and sensing across the User1/Device2 104 for content transfer. The different interactions indicate different commands. In some examples, when the first user is using User1/Device1 102, the initialization of User1/Device2 104 (e.g., a wearable device) automatically changes the input characteristics of User1/Device1 102. For example, an application such as, for example, Zoom has focus on a PC (e.g., the User1/Device1 102). In this example, the system 100 assumes a hand-raise gesture from the first user to indicate the first user intends to ask a question means that the hand-raise gesture should be indicated in Zoom because Zoom is the application running on the User1/Device1 102. If the if the first user has just put on a headset (i.e., the User1/Device2 104), the hand-raise gesture may have been intended for the headset. In some examples disclosed herein, that hand-raise gesture can have a different meaning because the system 100 has detected the headset is on the first user's head. In some examples disclosed herein, the content transfer circuitry 128 changes the operating characteristics of the User1/Device1 102 (e.g., the PC), and the User1/Device1 102 will ignore the hand-raise gesture for the Zoom application. Additionally or alternatively, the content transfer circuitry 128 assigned the hand-raise gesture a different purpose or command now that the User1/Device2 104 (e.g., the headset) is worn or otherwise initialized by the first user.

In addition to a hand-raise gesture, other air gesture input may be supported by one or more of User1/Device1 102 and/or the User1/Device2 104. For example, a virtual keyboard may be shown for gesture input. In another example, objects in a shared workspace can be held with a grasp gesture. In another example, gesture modes may be coordinated across devices as disclosed herein.

In some examples, the characteristics of the first user's view on the User1/Device2 104 (e.g., the HMD) alter the behavior of the User1/Device1 102 (e.g., the PC) regarding input. For example, if the User1/Device2 104 is in VR mode, the content transfer circuitry 128 acts as though the first user can no longer see the screen of the User1/Device1 102. Therefore, the content transfer circuitry 128 causes content to be presented in the VR of the User1/Device2 104. In some examples, if the User1/Device2 104 (e.g., the HMD) is in AR mode, the content transfer circuitry 128 acts as though the first user has potential for an extended screen experience. In such examples, the content transfer circuitry 128 continues to able gesture-based input to the User1/Device1 102. Thus, in this example gesture modes are coordinated across the User1/Device1 102 and the User1/Device2 104. In some examples, the coordinate gesture control is not based on sensor fusion, but rather, the content transfer circuitry 128 intelligently controls which device in the view of the first user is best to currently interpret a gesture command. For example, if the first user is targeting an object on the User1/Device1 102, the User1/Device1 102 may be best. If the User1/Device2 104 is showing a virtual workspace with a graspable object, the content transfer circuitry 128 may display the gesture recognition of the User1/Device1 102 during the AR mode of the User1/Device2 104.

Also, in some examples, the User1/Device2 104 (e.g., the HMD) enters a mode in which head movements and gaze control a cross-device cursor. In some examples, the first user can enter a mode so that when the first user looks at the User1/Device2 104, the content transfer circuitry 128 comprehends the potential for selecting a destination to move content. In some examples, head movements and other gestures are detected by one or more of the camera 110, the camera 136, and/the motion sensing circuitry 140, and the eye gaze is detected by one or more of the camera 110, the camera 136, eye tracking circuitry 116, and/or the eye tracking circuitry 146.

Gaze tracking across devices could be enabled in multiple ways. For example, the first user wears the User1/Device2 104 (e.g., the HMD), and the first user may glance at a window on the User1/Device1 102 (e.g., the PC) via passthrough of the User1/Device2 104. If the eye tracking circuitry 116 of the User1/Device1 102 and/or the eye tracking circuitry 146 of the User1/Device12 104 determines that first user holds their gaze at an item on the User1/Device1 102 for longer than a threshold period of time (e.g., 1 second), the User1/Device1 communication circuitry 144 of the User1/Device2 104 sends a message to the User1/Device1 102 to automatically switch to gaze tracking via the camera 110 of the User1/Device1 102. In another example, the communication circuitry 144 of the User1/Device2 104 sends a message to the User1/Device1 102 to highlight the window in question (or other item of interest). In some examples, the highlighting may include an effect such as, for example, a halo, outline, crosshair, selection box, etc. mapped onto the window or item. The first user then accepts or declines the change in gaze tracking from the User1/Device2 104 to the User1/Device1 102. In some examples, the gaze tracking of the User1/Device1 102 may not be of a high resolution enough to sense the gaze location. However, even in such examples, the first user would have feedback (via the highlighting) to see what is being selected. Then the first user could confirm by, for example, selecting a touch sensor on the User1/Device2 104.

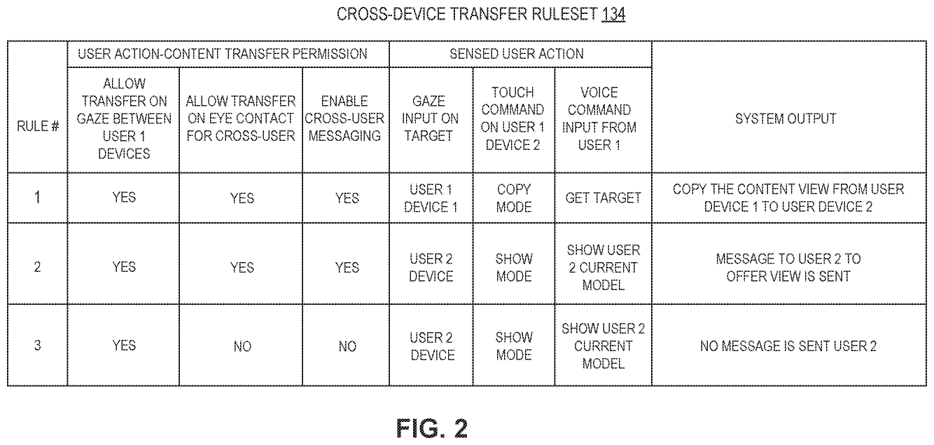

The interaction of the first user with one or more of the User1/Device1 102 and/or the User1/Device2 104 is to effect a command such as, for example, a command for transferring content between the User1/Device1 102 and the User1/Device2 104. Before the command is effected, the content transfer circuitry 128 compares the action to a ruleset (e.g., the cross-device transfer ruleset 134). For example, the content transfer circuitry 128 verifies compliance of the command with the cross-device transfer ruleset 134 based on one or more of context of the media or content to be transferred, the user identity, the type of device, the type of action used in the first user interaction with the User1/Device1 102 and/or the User1/Device2 104, and/or other parameters that may be implemented for facilitating or preventing cross device content transfer. These parameters are stored in the cross-device transfer ruleset 134. An example cross-device transfer ruleset 134 is shown in FIG. 2 and disclosed in further detail below.

When the content transfer circuitry 128 verifies compliance of the command with the cross-device transfer ruleset 134, the communication circuitry 134 of the User1/Device1 102 transfers the content to the User1/Device2 104. When the content transfer circuitry 128 determines that there is no compliance of the command with the cross-device transfer ruleset 134, the content transfer circuitry 128 of the User1/Device1 102 prevents transfers the content to the User1/Device2 104. In some examples, the content transfer circuitry 128 of the User1/Device1 102 provides a notification to the first user based on either approval and/or successful transfer of content to the User1/Device2 104 or a notification to the first user of denial of the content transfer based on lack of compliance with the cross-device transfer ruleset 134.

In some examples, the system 100 determines if the content is to be modified based on different characteristics of the User1/Device1 102 and/or the User1/Device2 104. For example, the output 130 the User1/Device1 102 and the output 154 of the User1/Device2 104 may use different formatting, different resolution, different display dimensions, different sound cards, different graphics processing capabilities, etc. If the content is to be modified one or more of the modification circuitry 126 of the User1/Device1 102 and/or the modification circuitry 152 of the User1/Device2 104 adjust the content (e.g., the format, the resolution, and/or the dimension, etc.) to create the modified content either before content transfer or after content transfer between the User1/Device1 102 and the User1/Device2 104. In some examples, the modification circuitry 126 of the User1/Device1 102 adjusts one or more portions of the content prior to content transfer to the User1/Device2 104, and the modification circuitry 152 of the User1/Device2 104 adjusts one or more portions of the content after receipt of content from the User1/Device1 102 to create the modified content.

As disclosed above, there may be different types of interactions between the devices 102, 104, 106 in the system 100. For example, the first user may use the User1/Device1 102 (e.g., an HMD) and the second user may use the User2/Device 106 (e.g., also an HMD). The first user may want to share the content view from the User1/Device1 102 to the User2/Device 106.

The proximity sensing circuitry 118 of the User1/Device1 102 and the proximity sensing circuitry 160 of the User2/Device 106 operate so the User1/Device1 102 detects the presence of the User2/Device 106 in proximity to the User1/Device1 102 and vice versa. The proximity sensing circuitry 118 of the User1/Device1 102 and/or the proximity sensing circuitry 160 of the User2/Device operate as disclosed above.

Devices detected in proximity also are authenticated to allow cross-device content transfer between the different users. The authentication circuitry 122 of User1/Device1 102 and/or the authentication circuitry 162 of the User2/Device 106 operate to effect authentication of the User2/Device 106. In some examples, the authentication circuitry 162 of the User2/Device 106 and/or the authentication circuitry 122 of User1/Device1 102 also operate to effect authentication of the User1/Device1 102. The User2/Device 106 is to be authenticated to verify that the User2/Device 106 is a trusted device for the User1/Device1 102 (or vice versa). The User2/Device 106 and/or the User1/Device1 102 may be authentication as disclosed above.

When the User2/Device 106 is authenticated or both User2/Device 106 and/or the User1/Device1 102 are cross-authenticated, the User1/Device1 102 may communicate with the User2/Device 106 including, for example, content sharing. There are different actions or combinations of actions the first user of the User1/Device 102 can make to share content with the second user of the User2/Device 106. The actions include actions disclosed above. Thus, content can be shared between the User1/Device 102 and the User2/Device 106 in accordance with examples disclosed herein for content transfer between the User1/Device 102 and the User1/Device 104. In addition, in some examples, the first user may use virtual eye contact, e.g., via an avatar of the first user and an avatar of the second user, to initiate transfer of content between the User1/Device1 102 and the User2/Device 106.

When a content transfer is initiated, the first user of User1/Device 102 confirms the selected content and the command as disclosed herein. In addition, the content transfer circuitry verifies compliance with the cross-device ruleset 134 as disclosed herein.

The content transfer circuitry 128 sends a notification to the second user of the User2/Device 106 to determine if the second user is willing to accept a content transfer from the User1/Device1 102. The notification may be presented via the output 168 of the User2/Device 106. The second user can reply, and the response is communicated via the communication circuitry 164 to the User1/Device1 106. The reply of the second user can accept or deny the content transfer from the User1/Device 106.

When the content transfer circuitry 128 verifies compliance of the command with the cross-device transfer ruleset 134, and the second user has accepted the content transfer, the communication circuitry 124 of the User1/Device1 102 transfers the content to the User2/Device 106. When the content transfer circuitry 128 determines that there is no compliance of the command with the cross-device transfer ruleset 134, and/or the second user denies the content transfer, the content transfer circuitry 128 of the User1/Device1 102 prevents transfers the content to the User2/Device 106. In some examples, the content transfer circuitry 128 of the User1/Device1 102 provides a notification to the first user based on either approval and/or successful transfer of content to the User1/Device2 104 or a notification to the first user of denial of the content transfer based on lack of compliance with the cross-device transfer ruleset 134 and/or was denied by the second user.

In some examples, the system 100 determines if the content is to be modified based on different characteristics of the User1/Device1 102 and/or the User2/Device 106. Such modifications can be assessed and implemented in accordance with the examples disclosed above with respect to the User1/Device2 104.

FIG. 2 shows an example cross-device transfer ruleset 134. The example ruleset 134 includes a plurality of rules. The ruleset 134 correlates user action with content transfer permissions (FIG. 2, columns 2-4). The ruleset 134 also maps user actions (FIG. 2, columns 5-7). The ruleset 134 also indicates a system output (FIG. 2, column 8). The system output is based on the user action/content transfer permission and the sensed user action. In some examples, compliance with the ruleset 134 is based on at least one of a type of the electronic device(s) and/or a type or identity of an operator (e.g., user) of the second electronic device. Other example user action/content transfer permissions, sensed user actions, and/or system outputs and/or combination thereof may be used other than shown in FIG. 2.

For example, according to Rule 1, a first user is allowed to transfer content between their devices (e.g., the User1/Device1 102 and the User2/Device2 104) using gaze (FIG. 2, column 2); the first user is allowed to transfer content to a second user (e.g., the second user of the User2/Device 106) using eye-contact (FIG. 2, column 3); and the first user is allowed to message with the second user (e.g., the second user of the User2/Device 106) (FIG. 2, column 4). If the first user makes one or more actions including gazing at a target on a first device (e.g., the User1/Device1 102) (FIG. 2, column 5); touching a command input such as, for example, an input button 148 on one of their second devices (e.g., the User1/Device2 104) (FIG. 2, column 6); or giving a voice command (FIG. 2, col. 7), will cause the content transfer circuitry 128 to effect content transfer by, for example, copying the content view from the User1/Device1 102 to the User1/Device2 104 (FIG. 2, col. 8).

In another example, according to Rule 2, a first user is allowed to transfer content between their devices (e.g., the User1/Device1 102 and the User2/Device2 104) using gaze (FIG. 2, column 2); the first user is allowed to transfer content to a second user (e.g., the second user of the User2/Device 106) using eye-contact (FIG. 2, column 3); and the first user is allowed to message with the second user (e.g., the second user of the User2/Device 106) (FIG. 2. column 4). If the first user makes one or more actions including gazing at the second user (e.g., the User2/Device 106) (FIG. 2, column 5); touching a command input such as, for example, an input button 148 on their device (e.g., the User1/Device1 102) (FIG. 2, column 6); or giving a voice command (FIG. 2, col. 7), will cause the content transfer circuitry 128 to send a message to the second user to offer the content transfer from the User1/Device1 102 to the User2/Device 106 (FIG. 2, col. 8).

In another example, according to Rule 3, a first user is allowed to transfer content between their devices (e.g., the User1/Device1 102 and the User2/Device2 104) using gaze (FIG. 2, column 2); the first user is not allowed to transfer content to a second user (e.g., the second user of the User2/Device 106) using eye-contact (FIG. 2. column 3); and the first user is not allowed to message with the second user (e.g., the second user of the User2/Device 106) (FIG. 2, column 4). If the first user makes one or more actions including gazing at the second user (e.g., the User2/Device 106) (FIG. 2, column 5); touching a command input such as, for example, an input button 148 on their device (e.g., the User1/Device1 102) (FIG. 2, column 6); or giving a voice command (FIG. 2, col. 7), will cause the content transfer circuitry 128 to prevent sending a message to the second user and/or otherwise transferring content transfer from the User1/Device1 102 to the User2/Device 108 (FIG. 2, col. 8).

The cross-device transfer ruleset 134 enables sanctioned actions to take place across devices 102, 104, 106. In some examples, a user interface (e.g., the other input 120) for such a ruleset 134 allow users to see and/or create defaults and to specify actions under various conditions. Also, in some examples, a third party such as for example, information technology (IT) management at an organization can allow some features to be removed if they do not meet an individual organization's security and/or other requirements.

FIG. 1 is a block diagram of system 100 for cross-device content transfer. Many elements of the system 100 of FIG. 1 may be instantiated (e.g., creating an instance of, bring into being for any length of time, materialize, implement, etc.) by processor circuitry such as a central processing unit executing instructions. Additionally or alternatively, the elements of the system 100 of FIG. 1 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 1 may, thus, be instantiated at the same or different times. Some or all of the circuitry may be instantiated, for example, in one or more threads executing concurrently on hardware and/or in series on hardware. Moreover, in some examples, some or all of the circuitry of FIG. 1 may be implemented by microprocessor circuitry executing instructions to implement one or more virtual machines and/or containers.

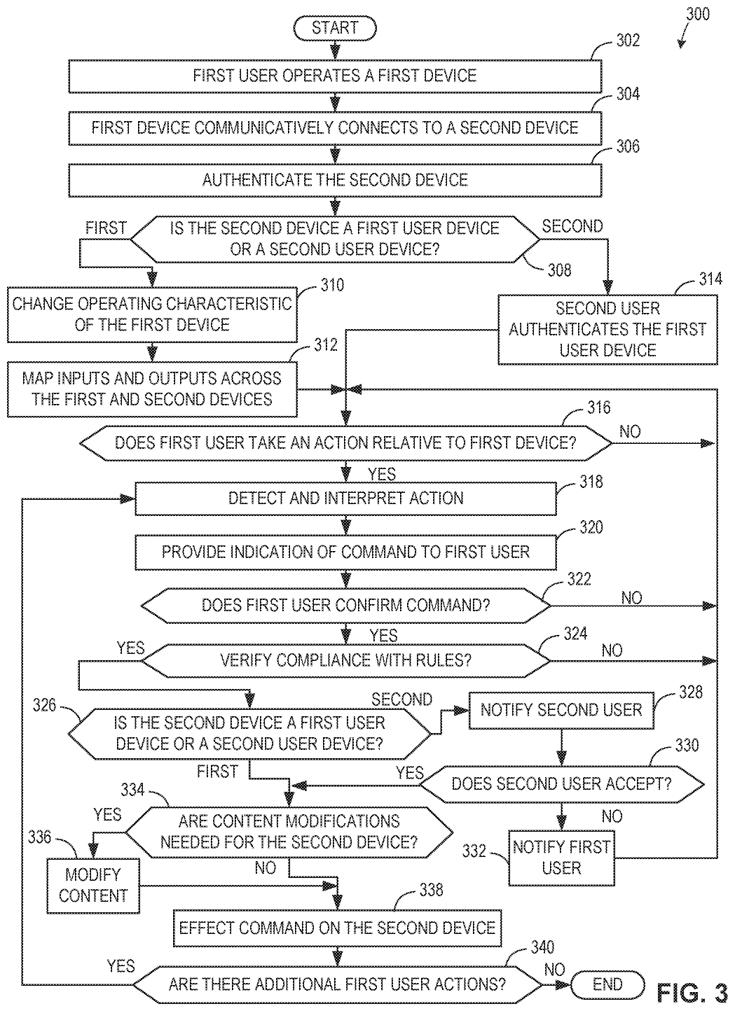

In some examples, the context tracking circuitry 114 is instantiated by processor circuitry executing context tracking instructions and/or operations such as those represented by the flowchart of FIG. 3. In some examples, the context tracking circuitry 114 is instantiated by processor circuitry executing context tracking instructions and/or operations such as those represented by the flowchart of FIG. 3.

In some examples, the context tracking circuitry 114 is instantiated by processor circuitry executing context tracking instructions and/or operations such as those represented by the flowchart of FIG. 3. In some examples, the eye tracking circuitry 116, 146 is instantiated by processor circuitry executing eye tracking instructions and/or operations such as those represented by the flowchart of FIG. 3. In some examples, the motion sensing circuitry 140 is instantiated by processor circuitry executing motion sensing instructions and/or operations such as those represented by the flowchart of FIG. 3. In some examples, the proximity sensing circuitry 118, 142, 160 is instantiated by processor circuitry executing proximity sensing instructions and/or operations such as those represented by the flowchart of FIG. 3. In some examples, the communication circuitry 124, 144, 164 is instantiated by processor circuitry executing communication instructions and/or operations such as those represented by the flowchart of FIG. 3. In some examples, the authentication circuitry 122, 150, 162 is instantiated by processor circuitry executing authentication instructions and/or operations such as those represented by the flowchart of FIG. 3. In some examples, the modification circuitry 126, 152, 166 is instantiated by processor circuitry executing modification instructions and/or operations such as those represented by the flowchart of FIG. 3. In some examples, the content transfer circuitry 128 is instantiated by processor circuitry executing context content transfer instructions and/or operations such as those represented by the flowchart of FIG. 3.

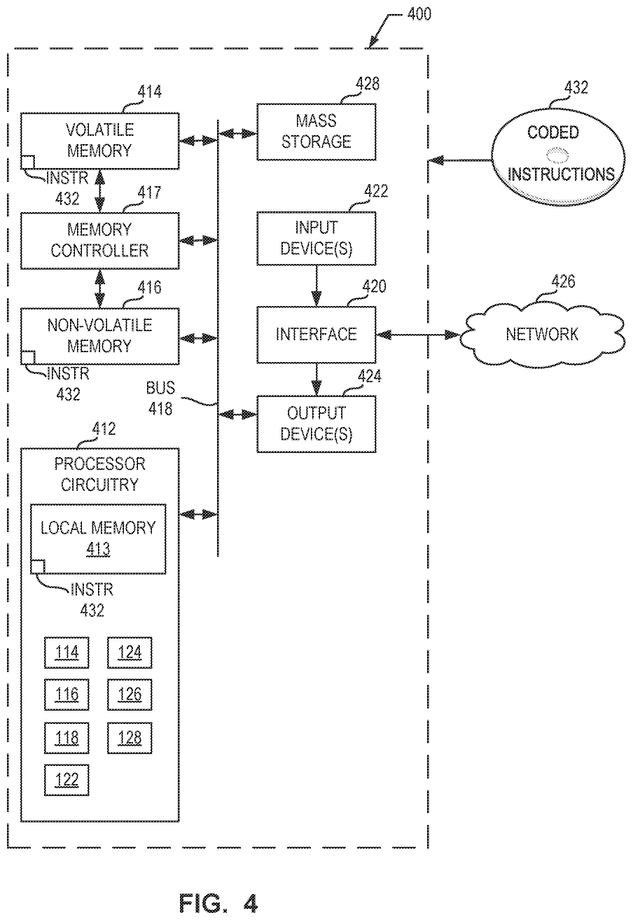

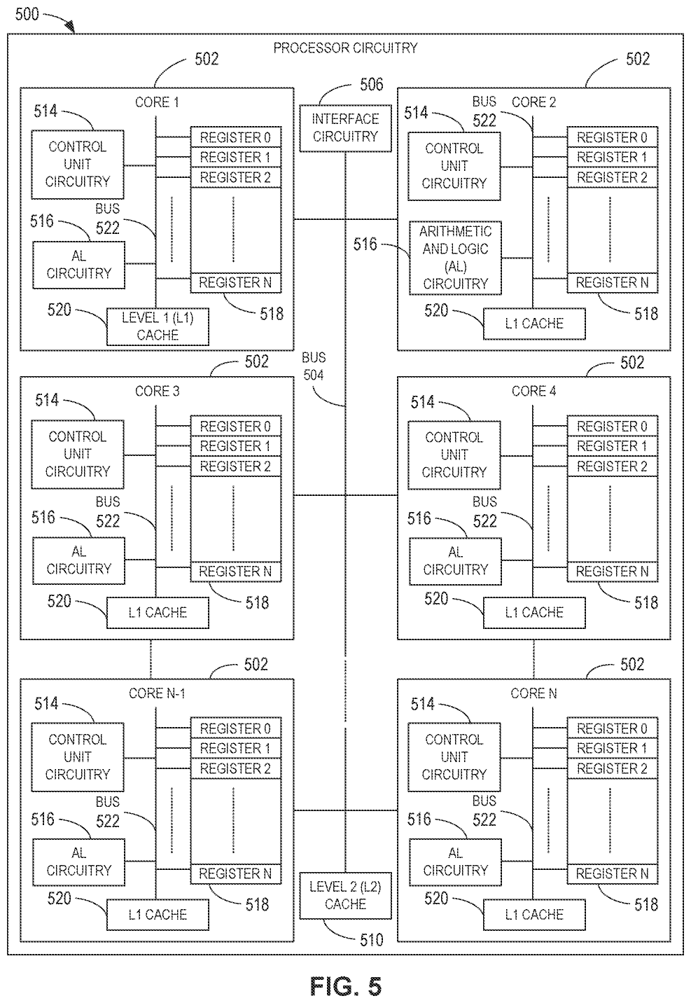

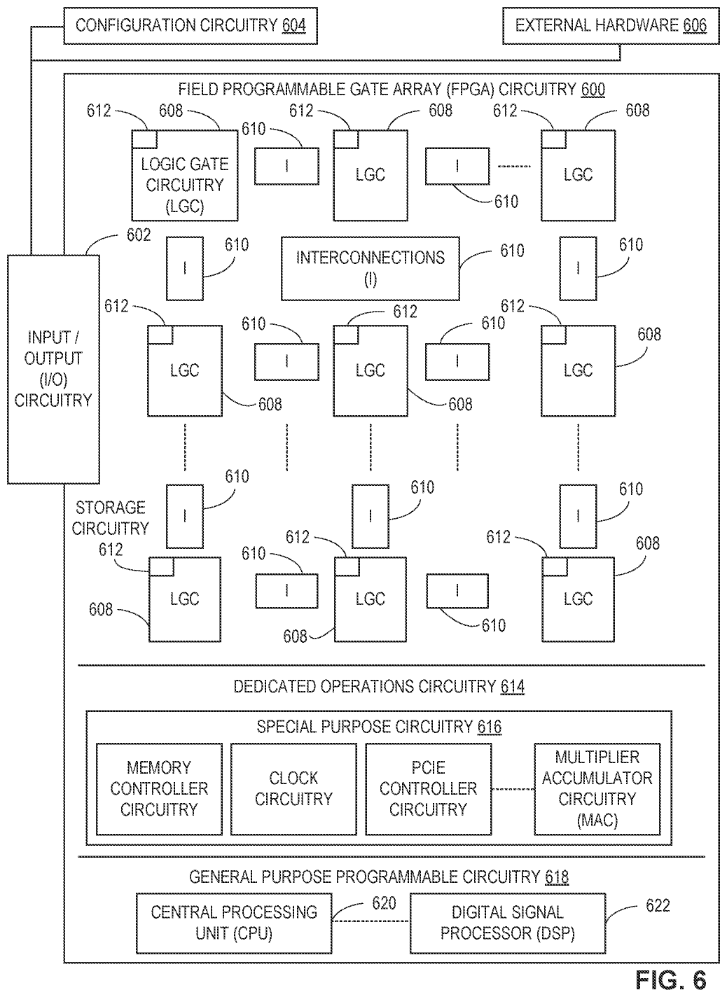

In some examples, the apparatus includes means for transferring content between devices. For example, the means for transferring may be implemented by the content transfer circuitry 128. In some examples, the content transfer circuitry 128 may be instantiated by processor circuitry such as the example processor circuitry 412 of FIG. 4. For instance, the content transfer circuitry 128 may be instantiated by the example microprocessor 500 of FIG. 5 executing machine executable instructions such as those implemented by at least blocks 310, 312, 314, 316, 320, 322, 326, 334, and 336 of FIG. 3. In some examples, the content transfer circuitry 128 may be instantiated by hardware logic circuitry, which may be implemented by an ASIC, XPU, or the FPGA circuitry 600 of FIG. 6 structured to perform operations corresponding to the machine-readable instructions. Additionally or alternatively, the content transfer circuitry 128 may be instantiated by any other combination of hardware, software, and/or firmware. For example, the content transfer circuitry 128 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the first device 102 of the first user is illustrated in FIG. 1, one or more of the elements, processes, and/or devices of the first device 102 of the first user illustrated in FIG. 1 may be combined, divided, re-arranged, omitted, eliminated, and/or implemented in any other way. Further, the example context tracking circuitry 114, the example eye tracking circuitry 116, the example proximity sensing circuitry 118, the example authentication circuitry 122, the example communication circuitry 124, the example modification circuitry 126, the example content transfer circuitry 128, and/or, more generally, the example first device 102 of the first user of FIG. 1, may be implemented by hardware alone or by hardware in combination with software and/or firmware. Thus, for example, any of the example context tracking circuitry 114, the example eye tracking circuitry 116, the example proximity sensing circuitry 118, the example authentication circuitry 122, the example communication circuitry 124, the example modification circuitry 126, the example content transfer circuitry 128, and/or, more generally, the example first device 102 of the first user, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example first device 102 of the first user of FIG. 1 may include one or more elements, processes, and/or devices in addition to, or instead of, those illustrated in FIG. 1, and/or may include more than one of any or all of the illustrated elements, processes and devices.

While an example manner of implementing the second device 104 of the first user is illustrated in FIG. 1, one or more of the elements, processes, and/or devices of the second device of the first user 104 illustrated in FIG. 1 may be combined, divided, re-arranged, omitted, eliminated, and/or implemented in any other way. Further, the example motion sensing circuitry 140, the example proximity sensing circuitry 142, the example communication circuitry 144, the example eye tracking circuitry 146, the example authentication circuitry 150, the example modification circuitry 152, and/or, more generally, the example second device 104 of the first user of FIG. 1, may be implemented by hardware alone or by hardware in combination with software and/or firmware. Thus, for example, any of the example motion sensing circuitry 140, the example proximity sensing circuitry 142, the example communication circuitry 144, the example eye tracking circuitry 146, the example authentication circuitry 150, the example modification circuitry 152, and/or, more generally, the example second device of the first user 104, could be implemented by processor circuitry, analog circuit(s), digital circuit(s), logic circuit(s), programmable processor(s), programmable microcontroller(s), GPU(s), DSP(s), ASIC(s), PLD(s), and/or FPLD(s) such as FPGAs. Further still, the example second device 104 of the first user of FIG. 1 may include one or more elements, processes, and/or devices in addition to, or instead of, those illustrated in FIG. 1, and/or may include more than one of any or all of the illustrated elements, processes and devices.

While an example manner of implementing the device 106 of the second user is illustrated in FIG. 1, one or more of the elements, processes, and/or devices of the device 106 of the second user illustrated in FIG. 1 may be combined, divided, re-arranged, omitted, eliminated, and/or implemented in any other way. Further, the example proximity sensing circuitry 160, the example authentication circuitry 162, the example communication circuitry 164, the example modification circuitry 166, and/or, more generally, the example device 106 of the second user of FIG. 1, may be implemented by hardware alone or by hardware in combination with software and/or firmware. Thus, for example, any of the example proximity sensing circuitry 160, the example authentication circuitry 162, the example communication circuitry 164, the example modification circuitry 166, and/or, more generally, the example device 106 of the second user, could be implemented by processor circuitry, analog circuit(s), digital circuit(s), logic circuit(s), programmable processor(s), programmable microcontroller(s), GPU(s), DSP(s), ASIC(s), PLD(s), and/or FPLD(s) such as FPGAs. Further still, the example device 106 of the second user of FIG. 1 may include one or more elements, processes, and/or devices in addition to, or instead of, those illustrated in FIG. 1, and/or may include more than one of any or all of the illustrated elements, processes and devices.

A flowchart representative of example machine readable instructions, which may be executed to configure processor circuitry to implement the first device 102 of FIG. 1, is shown in FIG. 3. The machine readable instructions may be one or more executable programs or portion(s) of an executable program for execution by processor circuitry, such as the processor circuitry 412 shown in the example processor platform 400 discussed below in connection with FIG. 4 and/or the example processor circuitry discussed below in connection with FIGS. 5 and/or 6. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 3, many other methods of implementing the example first device of the first user 102 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine-readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine-readable instructions may be fragmented and stored on one or more storage devices and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine readable media, as used herein, may include machine readable instructions and/or program(s) regardless of the particular format or state of the machine-readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 3 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine-readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 3 is a flowchart representative of example machine readable instructions and/or example operations 300 that may be executed and/or instantiated by processor circuitry to for cross-device content transfer. The machine-readable instructions and/or the operations 300 of FIG. 3 include the first user operating a first device such as, for example User1/Device1 102 (block 302). For example, the User1/Device1 102 may be a laptop computer. The first device communicatively connects to a second device, for example, User1/Device2 104 and/or the User2/Device 106 (block 304). For example, the proximity sensing circuitry 118 of the User1/Device1 102, the proximity sensing circuitry 142 of the User1/Device2 104, and/or the proximity sensing circuitry 160 of the User2/Device 105 may be used to detect one or the of the devices 102, 104. In some examples, User1/Device2 may be an HMD. Also, in some examples, the User2/Device 106 is a device operated by a second user. The instructions and/or operations 300 include authenticating the second device (block 306). For example, the authentication circuitry 122 verifies the identity and/or other characteristics of the second device.

The content transfer circuitry 128 determines if the second device is a first user device or a second user device (block 308). In some examples, the content transfer circuitry 128 makes this determination based on the authentication of the second device. If the second device is a first user device (e.g., the User1/Device2 104) (block 308: FIRST), the content transfer circuitry 128 changes one or more operating characteristics of the first device (block 310). For example, an input of the first device may be disabled or reconfigured for a different purpose. Other examples are disclosed above. The content transfer circuitry 128 also maps inputs and outputs across the first and second devices (block 312). For example, an input in one of the first device or the second device could lead to an output on either of the first device and/or the second device.

If the second device is a second user device (e.g., the User2/Device 106) (block 308: SECOND), the second user authenticates the first user device (block 314). For example, the authentication circuitry 162 of the User2/Device 106 verifies the identity and/or other characteristics of the first device (e.g., the User1/Device1 102).

Whether the second device is a first user device or a second user device, the instructions and/or operations 300 include the content transfer circuitry 128 determining if the first user takes an action relative to the first device (block 316). For example, the content transfer circuitry 128 can determine if the first user has held an eye gaze on the first device based on data gathered and/or generated by the eye tracking circuitry 116 and/or camera 110, issues a voice command based on data gathered by the microphone 112, and/or took other actions. If the user does not take an action (block 316: NO), the instructions and/or operations 300 remain idle. If the user takes an action (block 316: YES), the content transfer circuitry 128 detects and interprets the action (block 318). For example, the content transfer circuitry 128 detects that the eye gaze occurred and interprets the action as an intent to transfer or copy or share content of the first device with the second device.

The content transfer circuitry 128 provides an indication of the command to the first user (block 320). For example, the content transfer circuitry 128 provides a visual highlighting around the content to be copied. The content transfer circuitry 128 determines if the first user confirms the command (block 322). For example, the first user can tap a button, move their head, and/or make another sort of gesture or voice acknowledgment indicating a confirmation or rejection of the command. If the first user does not confirm the command (block 322: NO), the instructions and/or operations 300 continue with the content transfer circuitry 128 determining if the first user takes an action relative to the first device (block 316).

If the first user confirms the command (block 322: YES), the content transfer circuitry 128 determines if the action and command comply with the rules block 324). For example, the content transfer circuitry 128 determines if the action taken by the first user and the intended command are enabled by reference a ruleset such as, for example the ruleset 134. In an example disclosed above, the content transfer circuitry 128 determines if the first user can transfer media from the first device to the second device using an eye gaze. If the content transfer circuitry 128 determines that the action and command do not comply with the rules (block 324: NO), the instructions and/or operations 300 continue with the content transfer circuitry 128 determining if the first user takes an action relative to the first device (block 316).

If the content transfer circuitry 128 determines that the action and command do not comply with the rules (block 324: YES), the content transfer circuitry 128 again determines or references if the second device is a first user device or a second user device (block 326). In some examples, the operations and/or instructions of block 326 are not separately performed at this point, but rather, the content transfer circuitry 128 is already aware of the first user or second user classification of the second device based on prior assessments (e.g., block 308).

If the second device is a second user device (block 326: SECOND), the second user of notified via the second device (e.g., the User2/Device 106) that the first user and/or the first device (e.g., the User1/Device1 102) wants to share content (block 328). The second user has an opportunity to reject the content transfer. The content transfer circuitry 128 determines if the second user has accepted the content transfer (block 330). If the second user rejects the content transfer (block 330: NO), the first user is notified (block 332). For example, the content transfer circuitry 128 may cause a message to be displayed to the first user via the output 130 that indicates that the second user denied the content transfer. The instructions and/or operations 300 continue with the content transfer circuitry 128 determining if the first user takes an action relative to the first device (block 316).

If the second user accepts the content transfer (block 330: YES) and/or if the content transfer circuitry 128 determines that the second device is another one of the devices of the first user (block 326: FIRST), the content transfer circuitry 128 determines if content modifications are needed for the second device (block 334). For example, the content may need to be adjusted to a different format and/or resolution before presentation at the second device. If the content transfer circuitry 128 determines that content modifications are needed (block 334; YES), one or more of the modification circuitry 126 of the User1/Device1 102, the modification circuitry 152 of the User1/Device2 104, and/or the modification circuitry 166 of the User2/Device 106 modifies the content (block 336).

After the content is modified (block 336) and/or if the content transfer circuitry 128 determines that content modifications are not needed (block 334; NO), the content transfer circuitry 128 effects the command on the second device (block 338). For example, the content transfer circuitry 128 transfer the content to the second device.

The content transfer circuitry 128 determines if there are additional user actions (block 340). If the content transfer circuitry 128 determines that there are other user actions (block 340: YES), the instructions and/or operations 300 continue with the content transfer circuitry 128 determining if the first user takes an action relative to the first device (block 316). If the content transfer circuitry 128 determines that there are no other user actions (block 340: NO), the instructions and/or operations 300 end.

FIG. 4 is a block diagram of an example processor platform 400 structured to execute and/or instantiate the machine-readable instructions and/or the operations of FIG. 3 to implement the first device 102 of the first user of FIG. 1. Similar processor platforms 400 may also be used to implement the second device 104 of the first user and/or the device 106 of the second user. The processor platform 400 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 400 of the illustrated example includes processor circuitry 412. The processor circuitry 412 of the illustrated example is hardware. For example, the processor circuitry 412 can be implemented by one or more integrated circuits, logic circuits, FPGAs, microprocessors, CPUs, GPUs, DSPs, and/or microcontrollers from any desired family or manufacturer. The processor circuitry 412 may be implemented by one or more semiconductor based (e.g., silicon based) devices. In this example, the processor circuitry 412 implements context tracking circuitry 114, the eye tracking circuitry 116, the proximity sensing circuitry 118, the authentication circuitry 122, the communication circuitry 124, the modification circuitry 126, and the content transfer circuitry 128.

In the example in which the processor platform 400 implements the second device 104 of the first user, the processor circuitry 412 implements the motion sensing circuitry 140, the proximity sensing circuitry 142, the communication circuitry 144, the eye tracking circuitry 146, the authentication circuitry 150, and the modification circuitry 152.

In the example in which the processor platform 400 implement the device 106 of the second user, the processor circuitry 412 implements the proximity sensing circuitry 160, the authentication circuitry 162, the communication circuitry 164, and the example modification circuitry 166.

The processor circuitry 412 of the illustrated example includes a local memory 413 (e.g., a cache, registers, etc.). The processor circuitry 412 of the illustrated example is in communication with a main memory including a volatile memory 414 and a non-volatile memory 416 by a bus 418. The volatile memory 414 may be implemented by Synchronous Dynamic Random Access Memory (SDRAM), Dynamic Random Access Memory (DRAM), RAM BUS® Dynamic Random Access Memory (RDRAM®), and/or any other type of RAM device. The non-volatile memory 416 may be implemented by flash memory and/or any other desired type of memory device. Access to the main memory 414, 416 of the illustrated example is controlled by a memory controller 417.

The processor platform 400 of the illustrated example also includes interface circuitry 420. The interface circuitry 420 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 422 are connected to the interface circuitry 420. The input device(s) 422 permit(s) a user to enter data and/or commands into the processor circuitry 412. The input device(s) 422 can be implemented by, for example, an audio sensor, a microphone, a camera (still or video), a keyboard, a button, a mouse, a touchscreen, a trackpad, a trackball, an isopoint device, and/or a voice recognition system.

One or more output devices 424 are also connected to the interface circuitry 420 of the illustrated example. The output device(s) 424 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 420 of the illustrated example, thus, typically includes a graphics driver card, a graphics driver chip, and/or graphics processor circuitry such as a GPU.

The interface circuitry 420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 426. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 400 of the illustrated example also includes one or more mass storage devices 428 to store software and/or data. Examples of such mass storage devices 428 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine-readable instructions 432, which may be implemented by the machine-readable instructions of FIG. 3, may be stored in the mass storage device 428, in the volatile memory 414, in the non-volatile memory 416, and/or on a removable non-transitory computer readable storage medium such as a CD or DVD.

FIG. 5 is a block diagram of an example implementation of the processor circuitry 412 of FIG. 4. In this example, the processor circuitry 412 of FIG. 4 is implemented by a microprocessor 500. For example, the microprocessor 500 may be a general-purpose microprocessor (e.g., general purpose microprocessor circuitry). The microprocessor 500 executes some or all of the machine-readable instructions of the flowchart of FIG. 3 to effectively instantiate the circuitry of FIG. 1 as logic circuits to perform the operations corresponding to those machine-readable instructions. In some such examples, the circuitry of FIG. 2 [er diagram] is instantiated by the hardware circuits of the microprocessor 500 in combination with the instructions. For example, the microprocessor 500 may be implemented by multi-core hardware circuitry such as a CPU, a DSP, a GPU, an XPU, etc. Although it may include any number of example cores 502 (e.g., 1 core), the microprocessor 500 of this example is a multi-core semiconductor device including N cores. The cores 502 of the microprocessor 500 may operate independently or may cooperate to execute machine readable instructions. For example, machine code corresponding to a firmware program, an embedded software program, or a software program may be executed by one of the cores 502 or may be executed by multiple ones of the cores 502 at the same or different times. In some examples, the machine code corresponding to the firmware program, the embedded software program, or the software program is split into threads and executed in parallel by two or more of the cores 502. The software program may correspond to a portion or all of the machine-readable instructions and/or operations represented by the flowchart of FIG. _.

The cores 502 may communicate by a first example bus 504. In some examples, the first bus 504 may be implemented by a communication bus to effectuate communication associated with one(s) of the cores 502. For example, the first bus 504 may be implemented by at least one of an Inter-Integrated Circuit (I2C) bus, a Serial Peripheral Interface (SPI) bus, a PCI bus, or a PCIe bus. Additionally or alternatively, the first bus 504 may be implemented by any other type of computing or electrical bus. The cores 502 may obtain data, instructions, and/or signals from one or more external devices by example interface circuitry 506. The cores 502 may output data, instructions, and/or signals to the one or more external devices by the interface circuitry 506. Although the cores 502 of this example include example local memory 520 (e.g., Level 1 (L1) cache that may be split into an L1 data cache and an L1 instruction cache), the microprocessor 500 also includes example shared memory 510 that may be shared by the cores (e.g., Level 2 (L2 cache)) for high-speed access to data and/or instructions. Data and/or instructions may be transferred (e.g., shared) by writing to and/or reading from the shared memory 510. The local memory 520 of each of the cores 502 and the shared memory 510 may be part of a hierarchy of storage devices including multiple levels of cache memory and the main memory (e.g., the main memory 414, 416 of FIG. 4). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 502 may be referred to as a CPU, DSP, GPU, etc., or any other type of hardware circuitry. Each core 502 includes control unit circuitry 514, arithmetic and logic (AL) circuitry (sometimes referred to as an ALU) 516, a plurality of registers 518, the local memory 520, and a second example bus 522. Other structures may be present. For example, each core 502 may include vector unit circuitry, single instruction multiple data (SIMD) unit circuitry, load/store unit (LSU) circuitry, branch/jump unit circuitry, floating-point unit (FPU) circuitry, etc. The control unit circuitry 514 includes semiconductor-based circuits structured to control (e.g., coordinate) data movement within the corresponding core 502. The AL circuitry 516 includes semiconductor-based circuits structured to perform one or more mathematic and/or logic operations on the data within the corresponding core 502. The AL circuitry 516 of some examples performs integer-based operations. In other examples, the AL circuitry 516 also performs floating point operations. In yet other examples, the AL circuitry 516 may include first AL circuitry that performs integer-based operations and second AL circuitry that performs floating point operations. In some examples, the AL circuitry 516 may be referred to as an Arithmetic Logic Unit (ALU). The registers 518 are semiconductor-based structures to store data and/or instructions such as results of one or more of the operations performed by the AL circuitry 516 of the corresponding core 502. For example, the registers 518 may include vector register(s), SIMD register(s), general purpose register(s), flag register(s), segment register(s), machine specific register(s), instruction pointer register(s), control register(s), debug register(s), memory management register(s), machine check register(s), etc. The registers 518 may be arranged in a bank as shown in FIG. 5. Alternatively, the registers 518 may be organized in any other arrangement, format, or structure including distributed throughout the core 502 to shorten access time. The second bus 522 may be implemented by at least one of an I2C bus, a SPI bus, a PCI bus, or a PCIe bus

Each core 502 and/or, more generally, the microprocessor 500 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 500 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 6 is a block diagram of another example implementation of the processor circuitry 412 of FIG. 4. In this example, the processor circuitry 412 is implemented by FPGA circuitry 600. For example, the FPGA circuitry 600 may be implemented by an FPGA. The FPGA circuitry 600 can be used, for example, to perform operations that could otherwise be performed by the example microprocessor 500 of FIG. 5 executing corresponding machine-readable instructions. However, once configured, the FPGA circuitry 600 instantiates the machine-readable instructions in hardware and, thus, can often execute the operations faster than they could be performed by a general-purpose microprocessor executing the corresponding software.

More specifically, in contrast to the microprocessor 500 of FIG. 5 described above (which is a general purpose device that may be programmed to execute some or all of the machine readable instructions represented by the flowchart of FIG. 3 but whose interconnections and logic circuitry are fixed once fabricated), the FPGA circuitry 600 of the example of FIG. 6 includes interconnections and logic circuitry that may be configured and/or interconnected in different ways after fabrication to instantiate, for example, some or all of the machine readable instructions represented by the flowchart of FIG. 3. In particular, the FPGA circuitry 600 may be thought of as an array of logic gates, interconnections, and switches. The switches can be programmed to change how the logic gates are interconnected by the interconnections, effectively forming one or more dedicated logic circuits (unless and until the FPGA circuitry 600 is reprogrammed). The configured logic circuits enable the logic gates to cooperate in different ways to perform different operations on data received by input circuitry. Those operations may correspond to some or all of the software represented by the flowchart of FIG. 3. As such, the FPGA circuitry 600 may be structured to effectively instantiate some or all of the machine-readable instructions of the flowchart of FIG. 3 as dedicated logic circuits to perform the operations corresponding to those software instructions in a dedicated manner analogous to an ASIC. Therefore, the FPGA circuitry 600 may perform the operations corresponding to the some or all of the machine-readable instructions of FIG. 3 faster than the general-purpose microprocessor can execute the same.

In the example of FIG. 6, the FPGA circuitry 600 is structured to be programmed (and/or reprogrammed one or more times) by an end user by a hardware description language (HDL) such as Verilog. The FPGA circuitry 600 of FIG. 6, includes example input/output (I/O) circuitry 602 to obtain and/or output data to/from example configuration circuitry 604 and/or external hardware 606. For example, the configuration circuitry 604 may be implemented by interface circuitry that may obtain machine readable instructions to configure the FPGA circuitry 600, or portion(s) thereof. In some such examples, the configuration circuitry 604 may obtain the machine-readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 606 may be implemented by external hardware circuitry. For example, the external hardware 606 may be implemented by the microprocessor 500 of FIG. 5. The FPGA circuitry 600 also includes an array of example logic gate circuitry 608, a plurality of example configurable interconnections 610, and example storage circuitry 612. The logic gate circuitry 608 and the configurable interconnections 610 are configurable to instantiate one or more operations that may correspond to at least some of the machine-readable instructions of FIG. 3 and/or other desired operations. The logic gate circuitry 608 shown in FIG. 6 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 608 to enable configuration of the electrical structures and/or the logic gates to form circuits to perform desired operations. The logic gate circuitry 608 may include other electrical structures such as look-up tables (LUTs), registers (e.g., flip-flops or latches), multiplexers, etc.

The configurable interconnections 610 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 608 to program desired logic circuits.

The storage circuitry 612 of the illustrated example is structured to store result(s) of the one or more of the operations performed by corresponding logic gates. The storage circuitry 612 may be implemented by registers or the like. In the illustrated example, the storage circuitry 612 is distributed amongst the logic gate circuitry 608 to facilitate access and increase execution speed.

The example FPGA circuitry 600 of FIG. 6 also includes example Dedicated Operations Circuitry 614. In this example, the Dedicated Operations Circuitry 614 includes special purpose circuitry 616 that may be invoked to implement commonly used functions to avoid the need to program those functions in the field. Examples of such special purpose circuitry 616 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 600 may also include example general purpose programmable circuitry 618 such as an example CPU 620 and/or an example DSP 622. Other general purpose programmable circuitry 618 may additionally or alternatively be present such as a GPU, an XPU, etc., that can be programmed to perform other operations.

Although FIGS. 5 and 6 illustrate two example implementations of the processor circuitry 412 of FIG. 4, many other approaches are contemplated. For example, as mentioned above, modern FPGA circuitry may include an on-board CPU, such as one or more of the example CPU 620 of FIG. 6. Therefore, the processor circuitry 412 of FIG. 4 may additionally be implemented by combining the example microprocessor 500 of FIG. 5 and the example FPGA circuitry 600 of FIG. 6. In some such hybrid examples, a first portion of the machine readable instructions represented by the flowchart of FIG. 3 may be executed by one or more of the cores 502 of FIG. 5, a second portion of the machine readable instructions represented by the flowchart of FIG. 3 may be executed by the FPGA circuitry 600 of FIG. 6, and/or a third portion of the machine readable instructions represented by the flowchart of FIG. 3 may be executed by an ASIC. It should be understood that some or all of the circuitry of FIG. 1 may, thus, be instantiated at the same or different times. Some or all of the circuitry may be instantiated, for example, in one or more threads executing concurrently and/or in series. Moreover, in some examples, some or all of the circuitry of FIG. 1 may be implemented within one or more virtual machines and/or containers executing on the microprocessor.

In some examples, the processor circuitry 412 of FIG. 4 may be in one or more packages. For example, the microprocessor 500 of FIG. 5 and/or the FPGA circuitry 600 of FIG. 6 may be in one or more packages. In some examples, an XPU may be implemented by the processor circuitry 412 of FIG. 4, which may be in one or more packages. For example, the XPU may include a CPU in one package, a DSP in another package, a GPU in yet another package, and an FPGA in still yet another package.

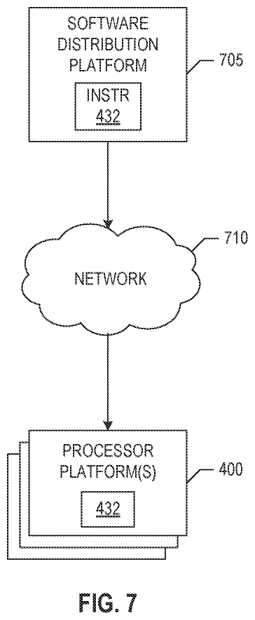

A block diagram illustrating an example software distribution platform 705 to distribute software such as the example machine readable instructions 432 of FIG. 4 to hardware devices owned and/or operated by third parties is illustrated in FIG. 7. The example software distribution platform 705 may be implemented by any computer server, data facility, cloud service, etc., capable of storing and transmitting software to other computing devices. The third parties may be customers of the entity owning and/or operating the software distribution platform 705. For example, the entity that owns and/or operates the software distribution platform 705 may be a developer, a seller, and/or a licensor of software such as the example machine readable instructions 432 of FIG. 4. The third parties may be consumers, users, retailers, OEMs, etc., who purchase and/or license the software for use and/or re-sale and/or sub-licensing. In the illustrated example, the software distribution platform 705 includes one or more servers and one or more storage devices. The storage devices store the machine-readable instructions 432, which may correspond to the example machine readable instructions 300 of FIG. 3, as described above. The one or more servers of the example software distribution platform 705 are in communication with an example network 710, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third-party payment entity. The servers enable purchasers and/or licensors to download the machine-readable instructions 432 from the software distribution platform 705. For example, the software, which may correspond to the example machine readable instructions 300 of FIG. 3, may be downloaded to the example processor platform 400, which is to execute the machine-readable instructions 432 to implement the first device of the first user 102. In some examples, one or more servers of the software distribution platform 705 periodically offer, transmit, and/or force updates to the software (e.g., the example machine readable instructions 432 of FIG. 4) to ensure improvements, patches, updates, etc., are distributed and applied to the software at the end user devices.

From the foregoing, it will be appreciated that example systems, methods, apparatus, and articles of manufacture have been disclosed that facilitate content transfer between devices based on commands given by user action. The devices could be different devices of a single user and/or devices between different users. Though examples disclosed herein relate to transfer from one device to another device, in some examples, there is no limit on the number of devices involved in the content transfer. In some examples, the rulesets governing content transfer can describe device categories enabling and/or preventing certain types of content transfer. Disclosed systems, methods, apparatus, and articles of manufacture improve the efficiency of using a computing device by seamlessly transferring content across devices and/or preventing content transfer across devices based singular and simple user action enabled via a customizable ruleset. Disclosed systems, methods, apparatus, and articles of manufacture are accordingly directed to one or more improvement(s) in the operation of a machine such as a computer or other electronic and/or mechanical device.

Examples disclosed herein facilitate cross-device content transfer. Example 1 includes a first electronic device that includes at least one memory; machine readable instructions; and processor circuitry to at least one of instantiate or execute the machine-readable instructions to: detect a second electronic device; detect an action of a user of the first electronic device; compare the action to a ruleset; facilitate transfer of content from the first electronic device to the second electronic device when the action complies with the ruleset; and prevent transfer of content from the first electronic device to the second electronic device when the action does not comply with the ruleset.

Example 2 includes the first electronic device of Example 1, wherein the processor circuitry is to change an operating characteristic of the first electronic device based on detection of the second electronic device.

Example 3 includes the first electronic device of Example 2, wherein the processor circuitry is to disable an input device of the first electronic device.

Example 4 includes the first electronic device of Examples 2 or 3, wherein the processor circuitry is to disable an output device of the first electronic device.

Example 5 includes the first electronic device of any of Examples 2-4, wherein the processor circuitry is to enable gesture recognition as input to the first electronic device.

Example 6 includes the first electronic device of any of Examples 1-5, wherein the action is an eye gaze of the user.

Example 7 includes the first electronic device of Example 6, wherein the eye gaze is held on the first electronic device.

Example 8 includes the first electronic device of Examples 6 or 7, wherein the user is a first user and the eye gaze is a virtual eye contact with an avatar associated with the second electronic device, the second electronic device operated by a second user.

Example 9 includes the first electronic device of any of Examples 1-8, wherein the processor circuitry is to modify the content for presentation at the second electronic device.

Example 10 includes the first electronic device of any of Examples 1-9, wherein the user is a first user the processor circuitry is to facilitate transfer of the content to the second device after receipt of authentication from the second electronic device, the second electronic device operated by a second user.

Example 11 includes the first electronic device of any of Examples 1-10, wherein compliance with the ruleset is based on at least one of a type of the second electronic device or an operator of the second electronic device.

Example 12 includes the first electronic device of any of Examples 1-11, wherein compliance with the ruleset is based on whether the first user is wearing the second electronic device.

Example 13 includes a non-transitory machine-readable storage medium comprising instructions to cause one or more processors to at least: detect an action of a user of a first electronic device; compare the action to a ruleset, the ruleset correlating a plurality of actions to a plurality of types of second electronic devices; facilitate transfer of content from the first electronic device to a second electronic device when the action complies with the ruleset; and prevent transfer of content from the first electronic device to the second electronic device when the action does not comply with the ruleset.

Example 14 includes the machine-readable storage medium of Example 13, wherein the instructions cause the one or more processors to change an operating characteristic of the first electronic device based on detection of a communication link between the first electronic device and the second electronic device.

Example 15 includes the machine-readable storage medium of Example 14, wherein the instructions cause the one or more processors to disable at least one of an input device or an output device of the first electronic device.

Example 16 includes the machine-readable storage medium of Examples 14 or 15, wherein the instructions cause the one or more processors to enable gesture recognition as input to the first electronic device.

Example 17 includes the machine-readable storage medium of any of Examples 13-16, wherein the action is an eye gaze of the user held on the first electronic device.

Example 18 includes the machine-readable storage medium of any of Examples 13-17, wherein the user is a first user and wherein the action is a virtual eye contact with an avatar associated with the second electronic device, the second electronic device operated by a second user.

Example 19 includes the machine-readable storage medium of any of Examples 13-18, wherein the instructions cause the one or more processors to modify the content for presentation at the second electronic device.

Example 20 includes a method to facilitate cross-device content transfer, the method comprising: comparing, by executing instructions with processor circuitry, an action of a user of a first electronic device to a ruleset, the ruleset correlating a plurality of actions to a plurality of types of electronic devices; causing, by executing instructions with the processor circuitry, transfer of content from the first electronic device to a second electronic device when the action complies the ruleset; and preventing, by executing instructions with the processor circuitry, the transfer of content from the first electronic device to the second electronic device when the action does not comply with the ruleset.

Example 21 includes the method of Example 20, further including: determining the action complies with the ruleset when the second electronic device is a first type of electronic device; and determining the action does not comply with the ruleset when the second electronic device is a second type of electronic device.

Example 22 includes a first electronic device that includes at least one memory; machine readable instructions; and processor circuitry to at least one of instantiate or execute the machine-readable instructions to: detect a second electronic device; detect an action of a user of the first electronic device; compare the action to a ruleset; and facilitate transfer of content from the first electronic device to the second electronic device based on whether the action complies with the ruleset.

Example 23 includes the first electronic device of Example 22, wherein the processor circuitry is to disable an input device of the first electronic device and to disable an output device of the first electronic device based on detection of the second electronic device.

Example 24 includes the first electronic device of Example 22 or Example 23, wherein compliance with the ruleset is based on a type of the second electronic device and an operator of the second electronic device.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. A first electronic device comprising:
at least one memory;
machine readable instructions; and
processor circuitry to at least one of instantiate or execute the machine-readable instructions to:
detect a second electronic device;
detect an action of a user of the first electronic device;
compare the action to a ruleset;
facilitate transfer of content from the first electronic device to the second electronic device when the action complies with the ruleset; and
prevent transfer of content from the first electronic device to the second electronic device when the action does not comply with the ruleset.

2. The first electronic device of claim 1, wherein the processor circuitry is to change an operating characteristic of the first electronic device based on detection of the second electronic device.

3. The first electronic device of claim 2, wherein the processor circuitry is to disable an input device of the first electronic device.

4. The first electronic device of claim 2, wherein the processor circuitry is to disable an output device of the first electronic device.

5. The first electronic device of claim 2, wherein the processor circuitry is to enable gesture recognition as input to the first electronic device.

6. The first electronic device of claim 1, wherein the action is an eye gaze of the user.

7. The first electronic device of claim 6, wherein the eye gaze is held on the first electronic device.

8. The first electronic device of claim 6, wherein the user is a first user and the eye gaze is a virtual eye contact with an avatar associated with the second electronic device, the second electronic device operated by a second user.

9. The first electronic device of claim 1, wherein the processor circuitry is to modify the content for presentation at the second electronic device.

10. The first electronic device of claim 1, wherein the user is a first user the processor circuitry is to facilitate transfer of the content to the second device after receipt of authentication from the second electronic device, the second electronic device operated by a second user.

11. The first electronic device of claim 1, wherein compliance with the ruleset is based on at least one of a type of the second electronic device or an operator of the second electronic device.

12. The first electronic device of claim 1, wherein compliance with the ruleset is based on whether the first user is wearing the second electronic device.

13. A non-transitory machine-readable storage medium comprising instructions to cause one or more processors to at least:
detect an action of a user of a first electronic device;
compare the action to a ruleset, the ruleset correlating a plurality of actions to a plurality of types of second electronic devices;
facilitate transfer of content from the first electronic device to a second electronic device when the action complies with the ruleset; and
prevent transfer of content from the first electronic device to the second electronic device when the action does not comply with the ruleset.

14. The machine-readable storage medium of claim 13, wherein the instructions cause the one or more processors to change an operating characteristic of the first electronic device based on detection of a communication link between the first electronic device and the second electronic device.

15. The machine-readable storage medium of claim 14, wherein the instructions cause the one or more processors to disable at least one of an input device or an output device of the first electronic device.

16. The machine-readable storage medium of claim 14, wherein the instructions cause the one or more processors to enable gesture recognition as input to the first electronic device.

17. The machine-readable storage medium of claim 13, wherein the action is an eye gaze of the user held on the first electronic device.

18. The machine-readable storage medium of claim 13, wherein the user is a first user and wherein the action is a virtual eye contact with an avatar associated with the second electronic device, the second electronic device operated by a second user.

19. The machine-readable storage medium of claim 13, wherein the instructions cause the one or more processors to modify the content for presentation at the second electronic device.

20. A method to facilitate cross-device content transfer, the method comprising:
comparing, by executing instructions with processor circuitry, an action of a user of a first electronic device to a ruleset, the ruleset correlating a plurality of actions to a plurality of types of electronic devices;
causing, by executing instructions with the processor circuitry, transfer of content from the first electronic device to a second electronic device when the action complies the ruleset; and
preventing, by executing instructions with the processor circuitry, the transfer of content from the first electronic device to the second electronic device when the action does not comply with the ruleset.

21. The method of claim 20, further including:
determining the action complies with the ruleset when the second electronic device is a first type of electronic device; and
determining the action does not comply with the ruleset when the second electronic device is a second type of electronic device.

22. A first electronic device comprising:
at least one memory;
machine readable instructions; and
processor circuitry to at least one of instantiate or execute the machine-readable instructions to:
detect a second electronic device;
detect an action of a user of the first electronic device;
compare the action to a ruleset; and
facilitate transfer of content from the first electronic device to the second electronic device based on whether the action complies with the ruleset.

23. The first electronic device of claim 22, wherein the processor circuitry is to disable an input device of the first electronic device and to disable an output device of the first electronic device based on detection of the second electronic device.

24. The first electronic device of claim 22, wherein compliance with the ruleset is based on a type of the second electronic device and an operator of the second electronic device.
